(19) United States
(12) Patent Application Publication
(10) Pub. No.: US 2011/0106736 A1
(43) Pub. Date: May 5, 2011

(54) SYSTEM AND METHOD FOR INTUITIVE USER INTERACTION

(75) Inventors: Eran Aharonson, Ramat HaSharon (IL); Itay Riemer, Tel Aviv (IL); Eran Dukas, Tel Aviv (IL)

(73) Assignee: INTUITIVE USER INTERFACES LTD., Netanya (IL)

(21) Appl. No.: 12/994,152

(22) PCT Filed: Apr. 5, 2009
(86) PCT No.: PCT/IL2009/000360

§ 371 Date: Nov. 23, 2010

Related U.S. Application Data
(60) Provisional application No. 61/075,760, filed on Jun. 26, 2008.

(51) Int. Cl. G06N 5/02; G06F 15/18

(52) U.S. Cl. 706/12; 706/46

(57) ABSTRACT

The disclosed method and apparatus provide prediction and suggestion of proposed actions a user of an electronic device is likely to want to do, at certain circumstances. The actions take into account historical activities made by the user, as well as incoming events, environmental data, external data, or any other source of information. Proposing the actions may be done by one or more engines, each relating to one or more aspects of the device, actions, events, activities, preferences and the like. The actions proposed by all engines are merged and prioritized, and presented to a user. The options are presented to a user in a manner that enables activation of any of the options, with the relevant settings and parameters.

### TECHNICAL FIELD

The present invention relates to user interfaces in general, and to a system and method for intuitive user interface for electronic devices, in particular.

### BACKGROUND

In recent decades, electronic devices have revolutionized our everyday lives. Devices such as Personal Digital Assistants (PDAs), mobile phones, smartphones, mobile media players, automotive infotainment devices, navigation systems, digital cameras, TVs and Set-top boxes have changed the lives of almost every person living in the developed world, and quite a number of people living in undeveloped countries. Mobile devices have become the means by which countless people conduct their personal and professional interactions with other people and organizations. It is almost impossible for many people, especially in the business world, to function productively without access to their electronic devices.

Due to the growing requirements for functionalities, and in order to avoid carrying multiple devices, multiple functionalities have been introduced to the same devices, such as a mobile phone which is also a camera and a navigation device. Additionally, each available function has ever growing number of settings, options and features.

The multiple functionalities, settings, features, and options have led to an inherent tradeoff between feature breadth and simplicity or convenience. It takes more understanding and more actions on the side of the user to activate the required functionality in the desired manner.

On the other hand, the hectic life style of many people, particularly in developed countries, causes people to forget or to neglect important or interesting but non-urgent tasks. Such tasks, of course, vary between people, or even for the same person in different circumstances.

There is thus a need in the art for a system and method that will enable users of electronic devices to utilize their devices in enhanced manner, which is easy, intuitive, personalized and adaptive.

### SUMMARY

A method and apparatus for proposing actions to a user of an electronic device, based on historical data or current data that may be external or associated with the user or the device. The proposed actions can also be changed in accordance with user preferences.

One aspect of the disclosure relates to a method for proposing a list of actions to a user of an electronic device, the method comprising: receiving a request for generating proposed actions; receiving a representation of historic information related to activities, events, or status, associated with the device or with the user or external to the device or to the user; receiving relevant information related to activities, events, or status, associated with the device or with the user or external to the device or to the user; determining a proposed action list comprising one or more proposed actions to the user of the device, based on the historic information or the relevant information; and activating an action with relevant parameters.

Within the method, the relevant information is optionally associated with the device or with the user. Within the method, the relevant information is optionally received from the device or from an external source. Within the method, the relevant information is optionally current information. The method can further comprise presenting to the user the proposed action list; and receiving an indication from the user about an action to be activated. The method can further comprise receiving an external offer; and combining the external offer into the proposed action list. The method can further comprise generating a random proposed action; and combining the random proposed action into the proposed action list. The method can further comprise a step of providing an explanation as to why the proposed action was suggested.

Within the method, each proposed action is optionally selected from the group consisting of: calling a person or a phone number; sending a message to a person or a group of persons or a phone number or a group of phone numbers; sending a predetermined message to a person or a group of persons or a phone number or a group of phone numbers; providing navigation instructions to a destination; providing navigation instructions to a destination in which the device was present, or to a destination indicated by the user; providing navigation instructions for a route the device travelled; suggesting the user to go to a store; suggesting the user to go to a restaurant; suggesting the user to go to a place of business; reminding a meeting appearing in a calendar of the device or in another calendar; providing to a user navigation instructions for a meeting appearing in a calendar of the device or in another calendar; sending a message to a meeting organizer if the user will be late or not arrive to a meeting appearing in a calendar of the device or in another calendar; activating a memo or voice-memo application in proximity to a meeting in a calendar; activating a medical instrument; activating an application used by the user; activating an application not used by the user; browsing an internet page or a Wireless Application Protocol (WAP) page; setting an alarm clock; playing a game; listening to a music file or a playlist; watching a video clip; activating remote devices such as a smart home; taking pictures; activating mobile payment application; logging expenses; activating mobile TV application with or without specific channel selection; activating mobile Radio application with or without specific channel selection; enabling Geographic tagging; activating an instant messaging application; activating an instant message to a specific person; activating an instant message carrying specific content; tracking a flight status; adding a to-do item; activating currency unit converter; reminding the user to perform health related tasks; locating a wireless network; locating a Wi-Fi network; logging information from any application; sending an e-mail; and checking information.

Within the method, the historic information or the relevant information optionally relate to activities or events selected from the group consisting of: a call made from the device; a call received or missed by the device; a message sent from the device; an e-mail message received or sent by the device; a message received by the device; sending information to an external system; a memo or voice-memo created on the device or imported thereto; activation of a medical instrument; activation of an application used by the user; browsing an internet page or a Wireless Application Protocol (WAP) page; setting an alarm clock; photos taken or viewed; a game played; music listened to as a file or a playlist; a video clip watched; activation of a remote device such as a smart home; mobile payments; expenses logged; mobile TV activation or channel selection; mobile radio activation or channel selection; geographic tagging; instant messaging application activation with recipient and content information; flight information; to-do item insertion; currency unit converter usage; activation of a health related task; wireless network such as Wi-Fi connection, disconnection or connection duration; logging information from any application; receiving information from an external system; and an application executed by the device.

Within the method, the historic information or the relevant information optionally relate to data selected from the group consisting of: raw time; time-zone; weather; temperature; humidity; daylight saving time information; lighting conditions; location data; raw location; relative location; music files or playlists; activation of remote devices, such as smart home; pictures taken; mobile payments application; expenses logging information; mobile TV application and channel selection information; mobile radio application and specific channel selection information; geographic tagging information; instant message application activation and target person information; flight status information; health related activities; to-do item creation or modification; currency unit converter information; information about activation or connection to new or existing wireless network such as Wi-Fi; logical location; proximity of a road or another physical location to a logical location; proximity to other users' device or entity; a received or missed call; a received message; a received e-mail; traffic information; personal information; a contact; a note; a message (SMS); an alarm; instant message; a document; a connection between a telephone number and a nickname; a user specific setting or modification made to the device settings; a received voice, picture, or video stream; processed voice, picture, or video stream; processing results of voice recognition, speaker verification, keyword spotting, full transcription, emotion recognition, or face recognition; a measure of an accelerometer or a barometer; a measure of a magnetic field sensor; a measure of a medical sensor; user initiated logging of an event; information received from an external source; information received from a social network; information received from an online data repository; an online application; web information; e-mail information; personal information; commercial information; a promotion; and another users' preference. Within the method, determining the proposed action list optionally uses one or more techniques selected from the group consisting of: clustering; k-means clustering, K-nearest neighbors; linear regression, Vector quantization (VQ); support vector machine (SVM); Hidden Markov Model; Conditional Random Fields, probit regression, logit regression, binomial regression, regression models of binary response variables, generalized linear model, rule based system, heuristic rules, expert systems, and artificial intelligence techniques. Within the method, the representation of the historic information is optionally a model. The method can further comprise a step of receiving an indication from the user relating to setting a priority for one or more actions or to eliminating one or more actions. Within the method, the request for generating proposed actions is optionally generated by a user or by an event, or received from a network; or generated according to a schedule or to a change in circumstances or data. The method can further comprise a step of updating the historic information with the action being activated. The method can further comprise a step of automatically activating one of the proposed actions. Within the method at least a part of determining the proposed action list is optionally performed by a processing unit external to the electric device.

Another aspect of the disclosure relates to an apparatus for proposing an action to a user of an electronic device, the apparatus comprising: a collection component for receiving information related to activities, events, or status, associated with the device or the user, or external to the device or to the user; a storage device for storing the information or a representation thereof; a request generation component for generating a request for generating a proposed action list; a prediction component, comprising one or more prediction engine for compiling a proposed action list comprising one or more proposed action related to information collected by the collection component; a user interface component for presenting the proposed action list to the user and receiving an action selected by the user or activated automatically, and a suggestion activation component for activating the action selected by the user with relevant parameters. The apparatus can further comprise a model construction component for generating a model representation of the information related to activities, events, or status, associated with the device or with the user, or external to the device or to the user. Within the apparatus, the prediction component optionally comprises one or more prediction engines, and a combination component for combining proposed actions provided by the prediction engines. Within the apparatus, proposed action is optionally selected from the group consisting of: calling a person or a phone number; sending a message to a person or a group of persons or a phone number or a group of phone numbers; sending a predetermined message to a person or a group of persons or a phone number or a group of phone numbers; providing navigation instructions to a destination; providing navigation instructions to a destination in which the device was present or to a destination indicated by the user; providing navigation instructions for a route the device travelled; suggesting the user to go to a store; suggesting the user to go to a restaurant; reminding a meeting appearing in a calendar of the device or in another calendar; providing to a user navigation instructions for a meeting appearing in a calendar of the device or in another calendar; sending a message to a meeting organizer if the user will not arrive to a meeting appearing in a calendar of the device or in another calendar; activating an application used by the user; activating an application not used by the user; browsing an internet page or a Wireless Application Protocol (WAP) page; setting an alarm clock; taking a photo; playing a game; activating a memo or voice-memo application in proximity to a meeting in a calendar; activating a medical instrument; listening to a music file or a playlist; watching a video clip; activating remote devices such as a smart home; taking pictures; activating mobile payment application and logging expenses; activating mobile TV application with specific channel selection; activating mobile radio application with specific channel selection; enabling geographic tagging; activating an instant messaging application; activating an instant message to a specific person; tracking a flight status; adding a to-do item; activating currency unit converter; reminding the user to perform health related tasks; locating a wireless network such as Wi-Fi; logging information from any application, sending an e-mail, and checking information. Within the apparatus the information is optionally related to activities selected from the group consisting of: a call made from the device; a call received or missed by the device, a message sent from the device; an e-mail message received or sent by the device; a message received by the device; sending information to an external system; receiving information from an external system; and an application executed by the device. Within the apparatus the information is optionally related to data selected from the group consisting of: raw time; time-zone; weather; temperature; humidity; daylight saving time information; lighting conditions; location data; raw location; relative location; logical location; proximity of a road or another physical location to a logical location; proximity to other users' device or entity; a received or missed call; a received message; a received e-mail; traffic information; personal information; a contact; a note; a message (SMS); an alarm; instant message; a document; a connection between a telephone number and a nickname; a user specific setting or modification made to the device settings; a received voice, picture, or video stream; processed voice, picture, or video stream; processing results of voice recognition, speaker verification, keyword spotting, full transcription, emotion recognition, or face recognition; a measure of an accelerometer or a barometer; a measure of a magnetic field sensor; a measure of a medical sensor; user initiated logging of an event; information received from an external source; commercial information; a promotion; music player information; video player information; remote device information, smart home information; camera information; mobile payment; logging expenses information; mobile TV information; mobile radio information; geographic tagging information; instant messaging information; flight status information; currency conversion information; health related information; wireless network information; and another users' preference. Within the apparatus, the prediction engine uses one or more techniques selected from the group consisting of: clustering; k-means clustering, K nearest neighbors; linear regression, Vector quantization; support vector machine; Hidden Markov Model; Conditional Random Fields, probit regression, logit regression, binomial regression, regression models of binary response variables, generalized linear model, rule based system, heuristic rules, expert systems, and artificial intelligence techniques.

Yet another aspect of the disclosure relates to a computer readable storage medium containing a set of instructions for a general purpose computer, the set of instructions comprising: receiving a request for generating proposed actions for an electronic device; receiving a representation of historic information related to activities, events, or status, associated with the electronic device or with a user of the electronic device or external to the device or to the user; receiving relevant information related to activities, events, or status, associated with the device or with the user or external to the device or to the user; determining a proposed action list comprising one or more proposed actions to the user of the device, based on the historic information or the relevant information; and activating an action from the proposed action list with relevant parameters.

### BRIEF DESCRIPTION OF THE DRAWINGS

The present invention will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a schematic illustration of a communication network in which the disclosed apparatus and method can be used;

FIG. 2 is a flowchart of the main steps in a method for proposing actions to a user of an electronic device, in accordance with the disclosure;

FIG. 3 is a flowchart of the main steps in a method for generating a model upon which actions to be proposed to a user are determined, in accordance with the disclosure;

FIG. 4 is a flowchart showing the main sub-steps in a method for determining the proposed actions, in accordance with the disclosure;

FIG. 5 is a schematic illustration of an exemplary method for suggesting proposed actions, in accordance with the disclosure;

FIG. 6 is a block diagram of the main components in an apparatus for proposing actions for a user of an electronic device, in accordance with the disclosure;

FIG. 7 is a schematic illustration of a mobile phone idle screen, as implemented in conventional devices; and

FIG. 8A and FIG. 8B are schematic illustrations of mobile phone screens which propose actions to a user, in accordance with the disclosure.

### DETAILED DESCRIPTION

A method and system for adaptive personal user interaction with electronic devices.

The method and system propose to a user of an electronic device, being in a given situation, a list comprising one or more plausible actions to be performed using the device. In order to compile the list, various sources of information related to the user or to the device information are used. The sources may include but are not limited to any historical, current or relevant information, such as: usage history information, data from sensors, external sources of information, heuristic rules, user's past actions, user characteristics and habits, user preferences, other users' information and usage patterns, situation based information (such as location, time, weather, base station, etc.), environment based information, information stored on the device, information about past and future meetings stored on the device, information from external sources such as a web calendar or a social network, address book information, or the like. The used information includes data stored on the device, as well as external data, such as data from the internet or any other source. In addition, the data may include data items related to the user or the device, as well as non-related data such as stock quotes, weather forecast, or the like.

The various sources of information are used in building a model, which is then used for predicting a set of proposed actions, based on the user's current or past preferences, activities, status and events, which may be related to the user or to the device, or be external. The system and method offer the actions to the user and enables their execution. In some embodiments, actions may be proposed as reoccurring, such as “add opening a web page every day at 10 AM”. Using the reoccurrence mechanism, proposed action will be scheduled to occur at a predetermined time, time interval, situation, or combination of events, for instance switching the phone to silent mode every time there is a meeting in the calendar and switching back after the meeting time is over. If the reoccurring action is cancelled one or more times, it may be suggested to a user at a later time to cancel the reoccurrence. The disclosure thus relates to providing a new usage paradigm to a user of the device, of a concrete-action-oriented environment associated with any given situation, whether the situation relates to the past, present, future or is an artificially generated situation, such as “what-if”. The paradigm can be used side-by-side with the existing multi-application-device paradigm, or can replace the multi-application-device paradigm.

Exemplary proposed actions may include but are not limited to: calling a person or a phone number; sending a message to a person or a group of persons or a phone number or a group of phone numbers or sending a message whose content is automatically produced by the system to a person or a group of persons or a phone number or a group of phone numbers, for instance: “I will be late” if according to a navigation system the user can not arrive on time to a distant meeting, “happy birthday” if the date is the recipient's birthday. Other proposed actions may include: providing navigation instructions to a destination; providing navigation instructions to a destination in which the device was present or to a destination indicated by the user; providing navigation instructions for a route the device travelled; suggesting to the user to go to a store; suggesting to the user to go to a restaurant; reminding a meeting appearing in a calendar of the device; activating an application used by the user; activating an application not used by the user; setting an alarm clock; sending an e-mail; playing a game; activating a memo or a voice-memo application; playing a music file or a playlist imported to the device or created on the device, when preference may be given to a newest piece or to a piece that was played recently or was not played in a long time; watching a video clip; activating remote devices such as a smart home; taking pictures; activating mobile payment application; logging expenses; activating mobile TV application with or without specific channel selection; activating mobile radio application with or without specific channel selection; enabling geographic tagging; activating an instant messaging application; activating an instant message to a specific person; tracking a flight status if the system is aware of a flight, for example if the flight appears in a calendar; adding a to-do item; activating currency unit converter, possibly with known units to convert to/from or a known amount; reminding the user to perform health related tasks; locating a wireless network such as Wi-Fi; logging information from any application, browsing the internet; following a specific internet link, checking information such as stock quotes, or performing any other action currently known to users of devices or that will become known in the future.

In some preferred embodiments, an explanation is provided for each proposed action, such as “Since you call Adam every Wednesday noon, and it is Wednesday noon now”, or “when you leave location X you usually go to location Y”, or the like.

The disclosure may be used for devices which may include but are not limited to mobile phones, smartphones, Personal Digital Assistants (PDAs), media players, automotive infotainment, digital cameras, personal navigation devices, TVs and Set-top boxes, VCRs and various other consumer electronics products. The proposed invention is not limited to consumer electronics devices, and could be applied to a wide variety of devices in various fields, including industrial, medical, transportation, or the like.

The information used for constructing the model and for predicting the proposed actions can relate to all types of available information, including but not limited to: timing data, including raw time and time-zone, the time and duration of an event such as a call, a message, or usage of any application, including but not limited to communication application, entertainment application, business application, health-related application, data retrieval application, or the like. The information can further include environmental data such as weather, temperature, humidity, daylight saving time, lighting conditions, or the like; location data, including raw location which can be obtained through multiple means, such as a global positioning system (GPS), current cell of a mobile communication device, relative location, logical location, road, the device's navigation application, proximity to a logical location such as home, work, restaurant, gym, or the like, proximity to other users, devices, or entities received via any technical means such as Bluetooth, RFID, Wi-Fi networks and others. Further information relates to incoming events received by the device, such as received or missed calls, messages, e-mails, notifications, traffic information or the like. Additional information items relate to information stored within the device, including action history, such as known previous actions, application usage, or the like, personal information, such as calendar, contacts, notes, messages (SMS), alarms, instant messaging, e-mails, documents, connection between a telephone number and a nickname, or the like; behavior and preferences, including user specific settings or modifications made to the device settings. Further information is received via input devices and sensors, including continuously or occasionally active sensors, and including data resulting from further processing made upon the received data, such as raw voice, pictures or video streams captured by the device, received voice, pictures or video streams, processed voice, pictures, or video streams, including processing results, such as voice recognition, speaker verification, keywords spotting, full transcription, emotion recognition, face recognition, or the like. Further sensors can include: an accelerometer, which can measure direction of gravity, linear or angular movement, tilt (roll, pitch) sensor measuring roll or pitch, shock or freefall sensing, a gyroscope measuring Coriolis effect, heading changes, rotation, barometric pressure sensor which measures atmospheric pressure, Indoor or urban canyon altitude, floor differentiation, height estimate, weather, or the like; magnetic field sensor, which measures direction of magnetic field, compass for absolute heading; medical sensors which measure heart rate, blood pressure, Electroencephalogram (EEG), electrocardiogram (ECG), or the like. Further information relates to user initiated logging, related to a general event or to a specific one, for example the user pushing a physical button or a touch screen button, with attached meaning, such as indicating a call as an important call, indicating a location as interesting, indicating an application as useful, or the like. Further information can be received from external sources, such as the internet or others, which may include personal information, commercial information and promotions, weather information, stock quote information, other users' preferences and data, or the like.

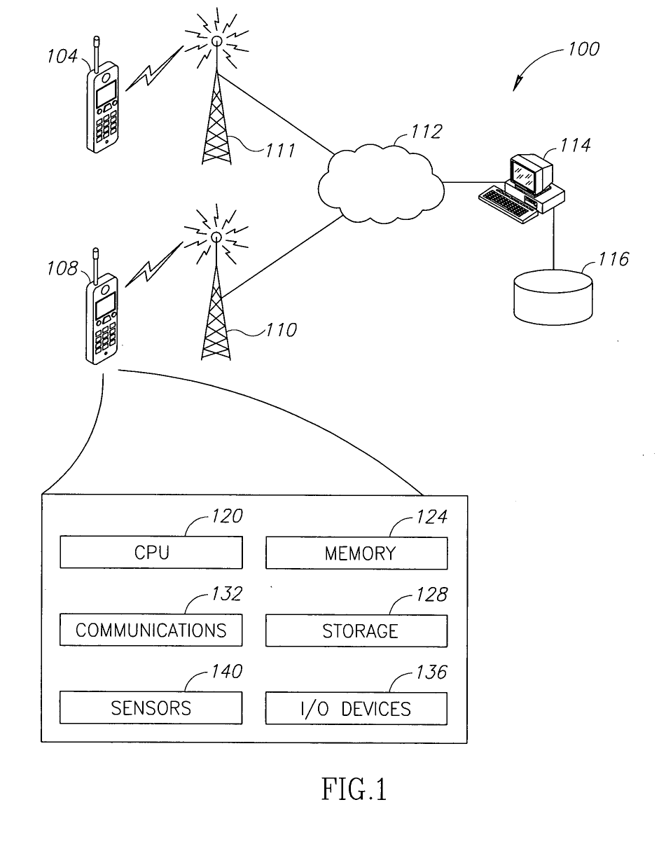

Referring now to FIG. 1, showing a schematic of a communication network, generally referenced 100, in which the disclosed apparatus and method can be used. It will be appreciated that the method and apparatus can also be used with other devices and in other contexts, and that the usage in the environment of FIG. 1 is exemplary only.

The environment includes one or more electronic devices, such as cellular device 1 (104) and cellular device 2 (108). Devices 104 and 108 can communicate with each other or with any other devices or systems, via communication network 112, which can use any wired or wireless technology or a combination thereof. In some embodiments, wireless communication is used employing technologies such as GSM, CDMA or others, in which devices 104 and 108 send and receive signals to and from one or more antennas such as antenna 110 or antenna 111.

The communication network can also include one or more servers such as server 114, which is optionally associated with storage 116. Server 114 can execute applications or provide services to devices 104, 108. Storage 116, which can reside anywhere in the network, can store application data, user data, device data, or the like. Server 114 or storage 116 can also store or communicate with elements not directly associated with the devices, such as computerized social networks, stock information, weather forecast, web mail servers, or the like. Each device such as mobile phone 104 comprises a processing unit 120, a volatile memory device 124, a storage device 128 for storing computer instructions as well as data, communication modules or components 132 for communicating with the relevant networks, and input output devices 136. Input/output devices 136 include one or more input devices, such as a keypad or a full keyboard, a touch screen that comprises one or more sensitive areas such as buttons, menus or other controls, a microphone, or any other control for enabling a user to provide input to the device, activate functions, or the like. Input/output devices 136 further include one or more output devices, such as a visual display device, one or more speakers, a vibrating device or the like, for providing indications to a user. The device optionally includes one or more sensors 140, such as a temperature sensor, an altitude sensor, movement sensors, a heartbeat sensor, or any other type of sensor.

The disclosed methods can be performed by one or more computing platforms comprising a processing unit, a storage unit, and a memory device. The methods can be performed by the device, by a processing unit external to the device, such as a server communicating directly or indirectly with the device, or by a combination thereof The methods are implemented as interrelated sets of computer instructions, such as executables, static libraries, dynamic link libraries, add-ins, active server pages, or the like. The computing instructions can be implemented in any programming language and developed under any development environment. The model or the information regarding the user's activities, status and event are stored on the storage device.

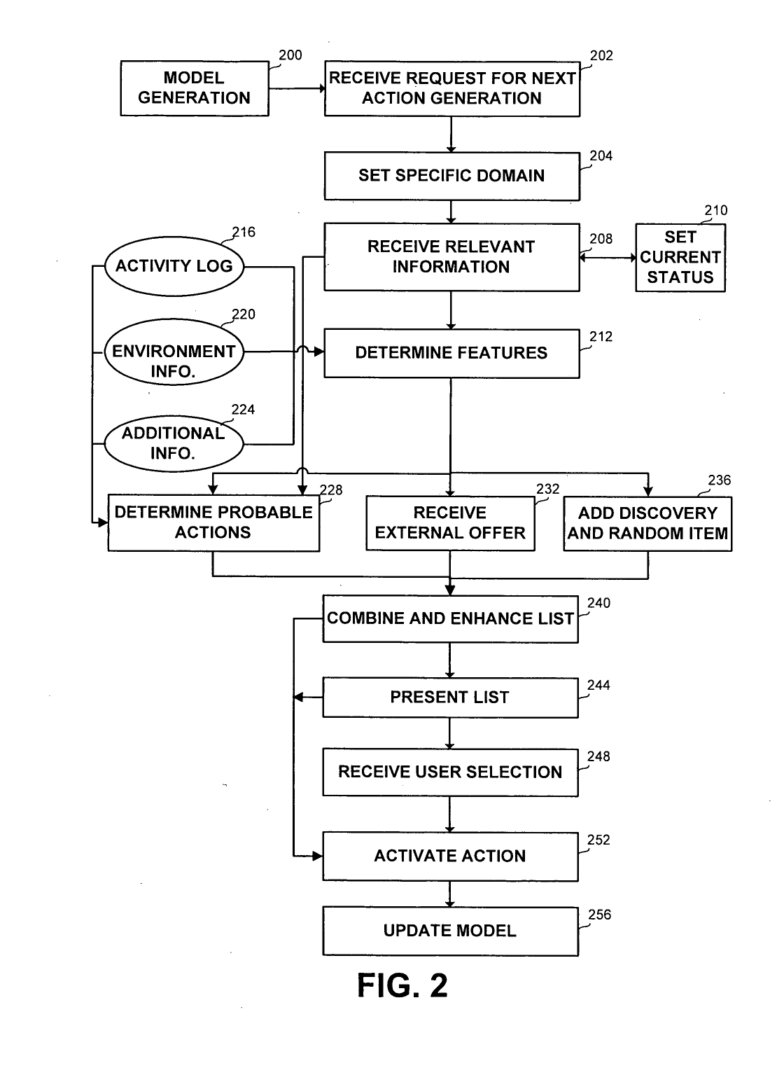

Referring now to FIG. 2, showing a flowchart of the main steps in a method for proposing actions to a user of an electronic device.

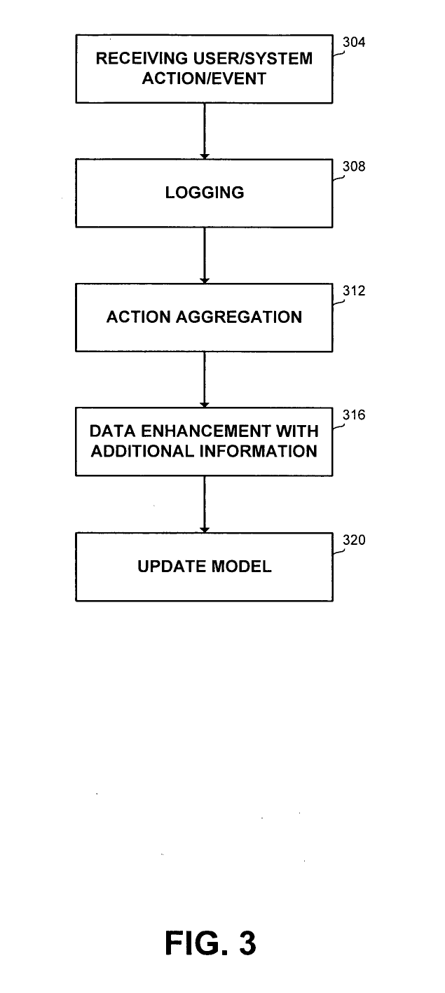

On step 200 one or more models for predicting or suggesting user actions is received. The model may include multiple decision-making mechanisms, which may apply rules, and be based on multiple historic or current actions, action types, events, status and data. The model is used for proposing actions of one or more types to a user, for a specific or any given situation. The construction or enhancement of the model is detailed in association with FIG. 3 below. The models can be stored on the device, or on any external storage, such as another device, a server, or the like.

On step 202 a request is received for generating a list of proposed actions. The request can be initiated automatically, for example by a periodic timer or according to a predetermined schedule, by detecting device movement, or according to the situation characteristics or a change in the situation characteristics, such as time, location, stock quote, external request, or the like. Alternatively, the request is initiated by a user of the device, by using a physical button, a touch screen button, voice command, finger gesture, or any other mechanism. In yet another alternative, the operation is initiated by an external system, or according to a request from a system external to the device.

On optional step 204, one or more domains are determined for the proposed actions. For example, the proposed actions may be limited to calls, messages, or the like.

On step 208, relevant information is received. The information may be associated with the device or with the user such as status of the device's sensors, or may be external, such as data from a web calendar, stock quotes, or the like. The relevant information may be received from the device or from an external source. The information may be current or relate to the past. Information can also be set to a pre-defined setting. The information may include time, location, proximity, personal data, active applications, history or the like. Optionally, an additional status may be received as well related to external information, such as information received from a web page, from a server the device is in communication with. On optional step 210, the status may be set externally.

On step 212 features are optionally determined from all available information sources, including the relevant status as well as additional items from the device's activity log 216, environmental information 220 such as weather or location, or additional information 224, such as information received from the internet, for example the user's calendar or online social network information or personal portfolio.

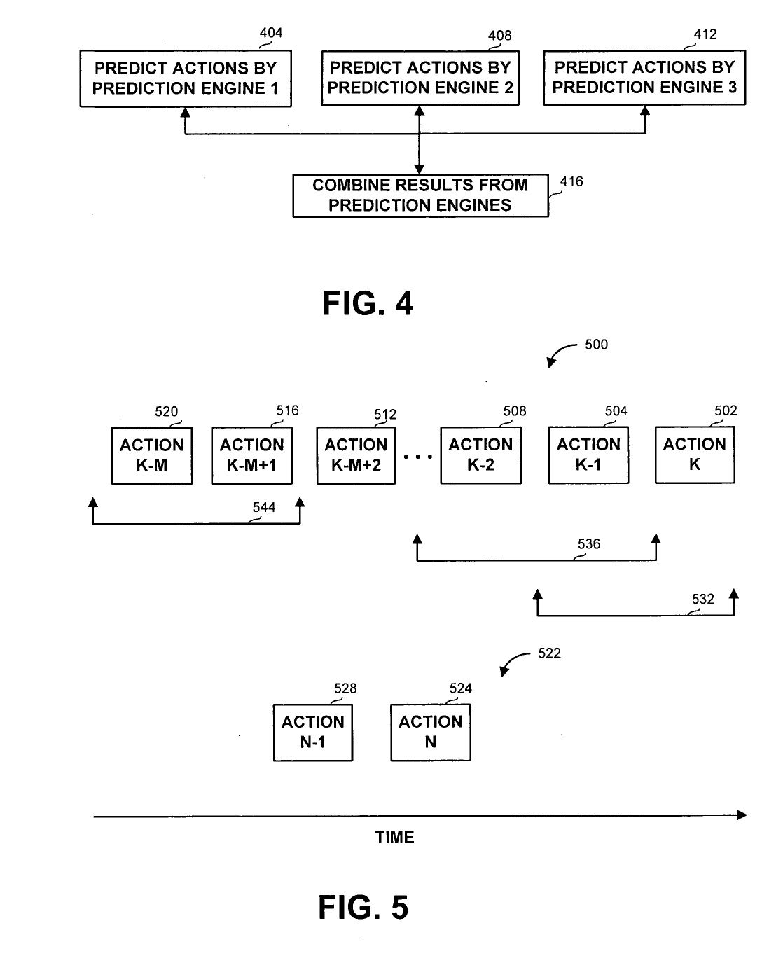

On step 228 probable actions for the current or other circumstances are determined based on the model and features. The actions can also be determined based on the trigger that initiated the proposed list generation. For example, if the trigger was a change in a stock quote, a probable action may be to surf to a web page in which the user can buy or sell stock. The actions can be limited to the specific type or domain set as determined on step 204. The action determination is detailed in association with FIG. 4 below. In another embodiment, the information regarding the current status, as well as the data from activity log 216, environmental information 220 and additional information 224 are received and used directly in determining proposed actions step 228. It will further be appreciated that although the data captured on step 208 or received from sources 216, 220, 224 is regarded as current data, it includes data related to actions or activities performed in the past. However, this data generally relates to the recent sequence of actions or activities, in order for the predicted actions to be applicable for the user in the present time and situation, or for an artificially generated situation, while the data upon which the model was constructed is older.

On optional step 232 external offers are received, such as external sponsored offers, for example to go into a nearby restaurant, or use operator preferences. Alternatively, the offer can be attached to and complementary to another proposed action, such as a coupon for a restaurant.

On optional step 236 additional items derived from the data or with some degree of random nature are determined. This can be done, for example by figuring out from the collected data a profile of the user, using clustering techniques for associating the user with a group of users having similar characteristics, such as age, occupation, geographical area or others, and analyzing actions taken by that group, which the person has not performed, which may seem ‘random’ to the user. The additional items may represent actions that the system anticipates the user is likely to take, as well as suggestions to discover new utilities and actions.

On step 240 the actions determined or received on steps 228, 232, and 236 are mixed, prioritized and the resulting proposed actions list is optionally enhanced. For example, duplicate or similar options are removed, if it is determined that one of the proposed actions is having lunch, a suggestion to go into a nearby restaurant that matches the user preferences can be made. In another example, if the user is scheduled to participate in a meeting, navigating to the location of the meeting may be suggested. In some embodiments, the combined list may be based on the user's profile, for example, how experienced the user is, what his preferences are, other users' data, operator or device creator decisions, or the like. It will be appreciated that in order to determine the proposed actions, user preferences can also be received and considered, including for example giving absolute or high priority to certain actions over others, such as sending a message over making a phone call, giving high priority to options involving a certain person or entity, such as one's home or office, or eliminating certain actions, such as actions associated with a particular person.

It will be appreciated that any of steps 228, 232, 236 or 240 can be performed by a processing unit residing on the device, by an external processing unit, such as a processing unit residing on a remote server, or by a combination thereof, wherein part of the processing is performed by the device and some processing is performed by an external unit. If processing is performed, at least in part, by an external unit, the results are communicated to the device via communication module 132 of FIG. 1.

On step 244 the list of options is presented to a user. The list may be arranged according to priority and can be changed by user preferences. In other embodiments, a list comprising multiple options is displayed to the user with no prioritization. If the user does not select any of the displayed options, a second list may be displayed, with or without the user indicating, for example by scrolling down, that he would like to view the second list. The second list may comprise proposed actions having lower priority than the items in the first list. The actions are presented to the user according to the hosting device User Interfaces (UI) paradigm. Alternatively, the proposed actions can be displayed to a user on a user interface external to the device.

On optional step 248 the user's selection of an item from the displayed list is received, and the selection is optionally logged. On step 252, the selected option is enabled, i.e. upon user selection the proposed action is activated. For example, if the user selected to make a suggested phone call, the system will initiate that call. If the user selected receiving navigation instructions, the navigating system will start, with the required location as destination, or the like. Alternatively, a proposed action having probability exceeding a predetermined threshold may be activated automatically, without receiving indication from the user, with or without being presented to the user, as indicated by the arrows leading to step 252 from step 240 and step 244. Optionally, automatic activation may be limited to performing only certain types of actions, such as navigation to a destination or accessing a web page.

On step 256, the user's selection may be used for updating or enhancing the model received on step 200.

The data collected on the steps detailed above, as well as the models is preferably stored on a storage unit associated with the electronic device. The storage can be on the device itself or on a detached unit, such as external storage, or a server which is in communication with the device, a combination thereof, or the like.

Referring now to FIG. 3, showing a flowchart of the main steps in a method for generating a model upon which the actions proposed to a user are determined.

On step 304, an event or action is received, which initiates the method. The event may be initiated by the user, such as a request to update the model, or a particular event that initiates the process, such as making a call, sending a message, activating an application, updating personal data, or the like, Alternatively, the event may be external, such as a current location report, an incoming call, or the like.

On step 308 the event is logged, either internally on the device or externally, for example on a server of the device operator, on a third party server, or the like.

On optional step 312, the logged events or activities may be aggregated into a more efficient form in order for example to save memory and remove repetitive data. For example nearby GPS positions may be aggregated into one item having a single position, and the position is associated with the accumulated duration at the position.

On optional step 316, the data may be enhanced by adding device-internal information, for example converting a phone number into a nickname by using the contacts application. If connection to external data exists, for example via online wired or wireless data connectivity, further information may be received for enhancing the logged information. Enhancements can include, for example, translation from GPS location to a logical address and type of place, such as the user's home, office or a known restaurant.

On optional step 320 one or more learning models are created or updated upon the collected information. The model can take any form of representation, such as a list, a tree, a statistical structure such as a histogram, or any other representation that can later be accessed by a prediction engine.

Referring now to FIG. 4, detailing the main sub-steps in an implementation of step 228 of FIG. 2, for determining the proposed actions.

Determining the proposed actions is preferably but not mandatory done by activating a number of engines using the constructed models, wherein each engine may activate one or more rules or suggests possible actions based on one or more aspects of information, either on device or external, such as associated with information from the internet. Thus, the method comprises multiple steps for predicting actions by a particular engine, such as step 404 for predicting actions by engine 1, step 408 for predicting actions by engine 2, or step 412 for predicting actions by engine 3. Each of the various engines receives some or all of the features extracted on step 212, and provide suggested actions. Each of the various engines and/or the result combination steps can be performed by the device or by another associated computing platform. Preferably, each engine provides multiple proposed actions. Preferably, a probability or likelihood is attached to each such action. The probability of a proposed action may be related, among other factors, to the time that had passed since the action or activity to which the proposed action relates. Thus, the system may assign higher priority to responding to a message received a short time ago than to responding to a message received a longer time ago.

On step 416, the actions suggested by all engines are combined into a single list, which may be fully, partially or not sorted by priority.

It will be appreciated that the engines and their underlying algorithms can be updated to reflect actions or choices made by multiple people, which can indicate a trend. For example, it may be discovered that once entering a meeting, many people switch their mobile phone to silent mode. Then, an engine may be configured to propose switching to silent mode when the user enters a meeting (i.e. arrived at the meeting's scheduled location in a corresponding time range).

The proposed actions are optionally fed back into the various engines, as shown by the two-way arrows in FIG. 4. In some embodiments, one or more engines may also receive or otherwise be aware of actions proposed by other engines. If not all engines are co-located on the same computing platform, any communication means between the engines for exchanging data can be used, including any wired or wireless communication means. It will be appreciated that the output of multiple engines can be combined, and that the output of one or more engines or combined results from multiple engines can be input to other engines. Each of the engines is executed by the device or by an external computing platform. Preferably, the prediction engines provides explanation to why a particular action was proposed, such as “you call X every Wednesday morning, and it is Wednesday morning now”, “You usually use application Y twice a week, and it's been two weeks since you used it”, or the like.

The prediction engines may attempt to automatically determine features or variables which are effective for predicting actions the user is likely to perform. Each prediction engine generates a list of items, preferably with a probability or a score assigned to each item. In an exemplary implementation, one engine may include prediction based on the day of the week, time, day, date, holidays, vacations and busy/free information, or the like. A different engine can be based on location, time, and movement type. A third engine can combine the two above mentioned engines for a system that generates proposed actions based on time and location, or the like. Each of the engines can use one or more techniques, including but not limited to techniques such as clustering, k-means clustering, K nearest neighbors, linear regression, Vector quantization (VQ), support vector machine (SVM), Hidden Markov Model (HMM), Conditional Random Fields (CRF), Probit regression, Logit regression, binomial regression, regression models of binary response variables, generalized linear model, rule based system, heuristic rules, expert systems, artificial intelligence techniques, or other methods.

Some exemplary implementations for proposing actions to a user of an electronic device are provided below.

The first example relates to the concept of the last used actions. At any point when it is required to propose the next actions, one or more of the last activated actions or received events, such as missed calls or received messages are processed in order to propose actions to the user. For example, if the user recently called three persons, sent a message to one person and had a missed call, these options (including calling back the person who made the missed call) can be suggested. The length of the history considered can vary according to preferences or requirements. In selecting the options, events that occurred more than once can receive higher priority.

The second example relates to a prediction system based on correlation between sequences of events. A list of historical events is generated, which comprises events in chronological order. The events may include calling a particular person, sending a message to a particular person, activating an application, or the like. Each event may be associated with any level of relevant details. Thus, an event may be “launching an application”, “making a phone call”, “making a phone call to a person X”, “making a phone call to a person X on time T”, or the like.

Then when it is required to generate a list of proposed actions, it is attempted to match a given sequence of the K previous actions to a past sequence of K actions which most resembles the given sequence, and then propose one or more actions that occurred after that past sequence.

Referring now to FIG. 5, demonstrating the search for a corresponding sequence. An exemplary list 500 of past events comprises action K (502), action K-1 (504) which precedes action K (502), action K-2 (508) which precedes action K-1 (504) and so on until action K-M+2 (512), action K-M+1 (516) and action K-M (520), so that the sequence comprises M+1 events, for some M.

It is required to propose the next actions for the current sequence of actions 522, comprising action N (524) and action N-1 (528). The current sequence is of length two for demonstration purposes only. Any other current sequence length can be used as well. For proposing the next actions after sequence 522, a sub-sequence sequence 500 which comprises two items that correspond to the items of sequence 522 are searched for. The options include sequence 532 which comprises action K (502) and action K-1 (504), sequence 536 which comprises action K-1 (504) and action K-2 (508), and so on until sequence 544 comprising action K-M+1 (516) and action K-M (520). Out of all possible sequences, either the highest matching one or more sequences are indicated, all sequences which match to at least a certain degree are indicated, or any other group is selected according to any selection criteria. If multiple sequences having the same or similar score are determined, optionally the later one is selected. For the selected sequences, the one or more actions following the sequence are indicated as proposed next actions. For example, if sequence 544 is selected, then action K-M+2 (512) or any other following action is proposed, if sequence 536 is selected then action K (512) is proposed as a next action. A match between sequence 522 and a sub-sequence of sequence 500 can be determined according to the number of matching actions between items in the sequences.

It will be appreciated many options are possible for the length of the historical sequence, K, the length of the current sequence, the level of detail characterizing every action, the matching mechanism, and the method according to which matching sequences are selected. The specific choice can vary according to multiple factors, including for example relevant periods of time, processing power of the device or associated computing platforms, the diversity of user actions, or other factors.

A third example relates to arriving to a scheduled meeting. If at a given time a meeting is scheduled at reasonably close time, for example 30 minutes, and the distance between the current location and the target location enables the user to arrive to the meeting on time, optionally taking into account traffic considerations, at the appropriate time the system will propose navigating to the meeting. If the distance between the current location of the user and the target location does not enable the user to arrive to the meeting on time, the system may also propose the user to send a message to the meeting organizer indicating he or she will be late.

A fourth example relates to identifying the route travelled by the user and proposing navigation instructions. In this example, routes taken by the user are stored.

A new route is recognized by a constant change in the location of the device, preceded and followed by the device being for a while at a constant location, or in the proximity thereof.

Then, when a user starts a new route, it is checked whether the new route, as identified by the varying locations, is a sub-sequence or a prefix of a past route. If this is the case, navigation instructions for the rest of the route are suggested. For example, suppose the system identifies that a person is leaving his home and is heading north on a certain road. Past routes travelled by the user include one or more trips in which the user left his home and travelled the same road, and arrived at a particular destination. The system will then propose the user to receive navigation instructions to that particular destination. In some embodiments, if the user travelled that route many times, the navigation instructions may not be proposed since the user is assumed to be familiar with the way.

A fifth example relates to offering a user substantially constant actions, or actions that were not used lately. For example, the system may find out that the user of the device speaks with a particular person about every month. If a period of time that is close to one month, for example three weeks has passed since they last talked, the system may suggest to the user to call that person. In another embodiment, if a user calls another person at a certain time everyday, the system may suggest to call him on or near that time. The same scenarios may be applied towards sending messages and activating applications. In one embodiment, the system may identify an application that was not used recently and suggest to the user to activate it again.

Referring now back to FIG. 4. Step 416 of combining results from multiple prediction engines can also be implemented in a multiplicity of ways. In one embodiment, the final action list is constructed based on the probability attached to each item received from each engine, with optionally taking past user selections into account, for example by assigning higher weights to actions proposed by a particular engine based on the user's past selections. All engines supply all suggested actions, with their associated probabilities. All items from all engines are merged into a single list which is sorted by probability, user preferences, past user selections of proposed items, external information, and the actions associated with the higher probabilities are displayed to the user.

In another embodiment, each engine only provides a predetermined number of options, comprising only the options that were assigned the highest probabilities. These partial lists are then merged, sorted, and the actions having the highest probabilities are displayed. In both embodiments, duplicate actions arrived at by different engines may be removed.

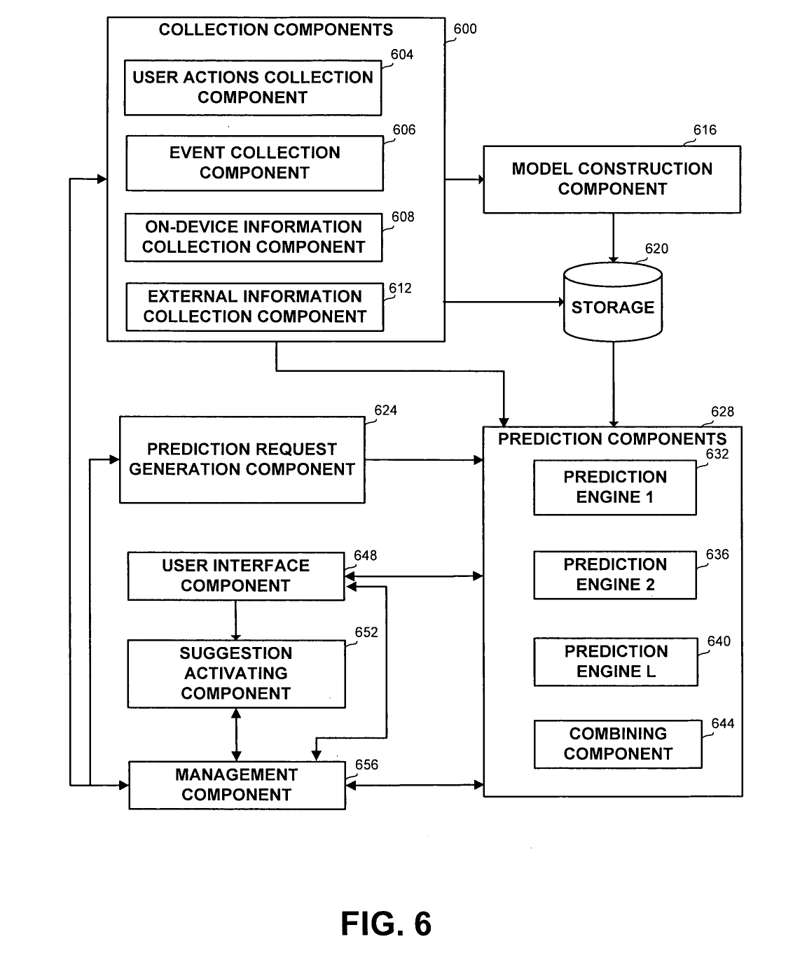

Referring now to FIG. 6, showing a block diagram of the main components in an apparatus for proposing actions for a user of an electronic device.

The apparatus comprises collection components 600, which further comprise user actions collection component 604, for collecting the actions the user performed in the last predetermined period of time. The actions may include calls made from the device, messages sent from the device, calls received by the device and answered or missed by the user, used applications, or the like.

Collection components 600 further comprises incoming event collection component 606 for collecting data related to events incoming into the device, such as missed calls, location reporting, time and weather reporting, other sensors information, or the like.

Another component of collection components 600 is on-device information collection component 608, for collecting data stored on the device, such as calendar, address book, destinations the user navigated to, or the like.

Collection components 600 also comprise external information collection component 612 for receiving or collecting information from external sources, such as weather reports, stock quotes, social networks, network based calendar, address book or email, or the like. The external information can be received via any channel or protocol the device can communicate through, such as the Internet, cellular networks, or the like.

All information collected by collection components 600 are used by model construction component 616 for constructing one or more models comprising one or more rules upon which actions are to be suggested to the user.

Some or all of the collected information or the constructed models are stored in storage device 620, which can be an on-device storage unit, an external storage unit, or a combination thereof.

The process of generating proposed action list is initiated by prediction request generation component 624, which is responsible for initiating the process, based on a schedule, a time interval since the last action generation, user request, external event, or any other trigger.

Upon initiation of the prediction request, and using the models constructed by model construction component 616, prediction components 628 compile a list of the proposed actions to be proposed to a user of the device. Prediction components 628 also use collection components 600 or data collected by collection components 600 and stored in storage 620, in order to generate upon the latest actions or events a list of proposed actions. Prediction components 628 comprise one or more specific prediction engines, such as prediction engine 1 (632), prediction engine 2 (636), prediction engine L (640), as described and exemplified in association with FIG. 4 above. Prediction components 628 may reside on and be executed by the device, where in some components, modules, libraries or the like may reside and be executed on an associated storage, such as over the network. Prediction components 628 further comprise combining component 644 for generating a single list of proposed actions, by combining and prioritizing the actions suggested by the various prediction engines such as prediction engine 1 (632), prediction engine 2 (636), or prediction engine L (640). Combining component 644 is also responsible for removing duplicate or similar actions from the combined action list. User preferences and past action selections may also be taken into account in merging the lists.

The suggested actions are displayed to a user by user interface component 648, according to the hosting device user interfaces paradigm. User interface component 648 also enables a user to select one or more of the suggested options. Once the user has made his choice, it is logged and may be used for updating the models.

If the user selected an item of the proposed actions list, the selected action is activated with the relevant parameters by suggestion activating component 652, which for example initiates a call to a person or a number, sends a predetermined message to a person or a number, enables a user to type a message to a person or a number, activates a navigation device to a particular destination, activates an application, or the like. The system can optionally record the user selection in order to feed the result back into the system in order to improve the prediction engines or the combining component.

It will be appreciated that if a proposed action has high probability, for example probability exceeding a predetermined threshold, the proposed action can be executed automatically, without waiting for the user's selection.

The apparatus further comprises a management component 656 for activating the various components, and managing the control and information flow within the apparatus.

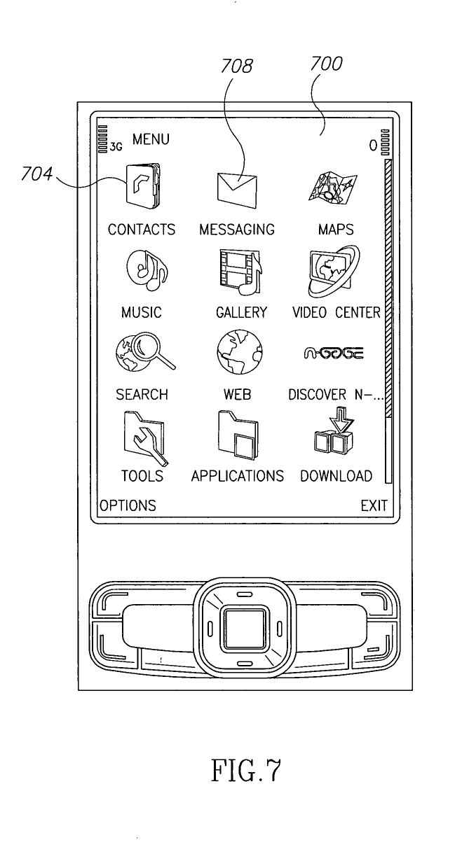

Referring now to FIG. 7, showing an illustration of a conventional idle screen 700 of a mobile phone. The user interface comprises icons, such as contacts icon 704, messaging icon 708 and others, enabling the most common activities the user can initiate from the screen. Although idle screen 700 is sometimes adaptable and can be enhanced according to the user's preferences, it is substantially constant and does not change according to the circumstances, latest activities initiated by the user, the user's habits, incoming events or other factors.

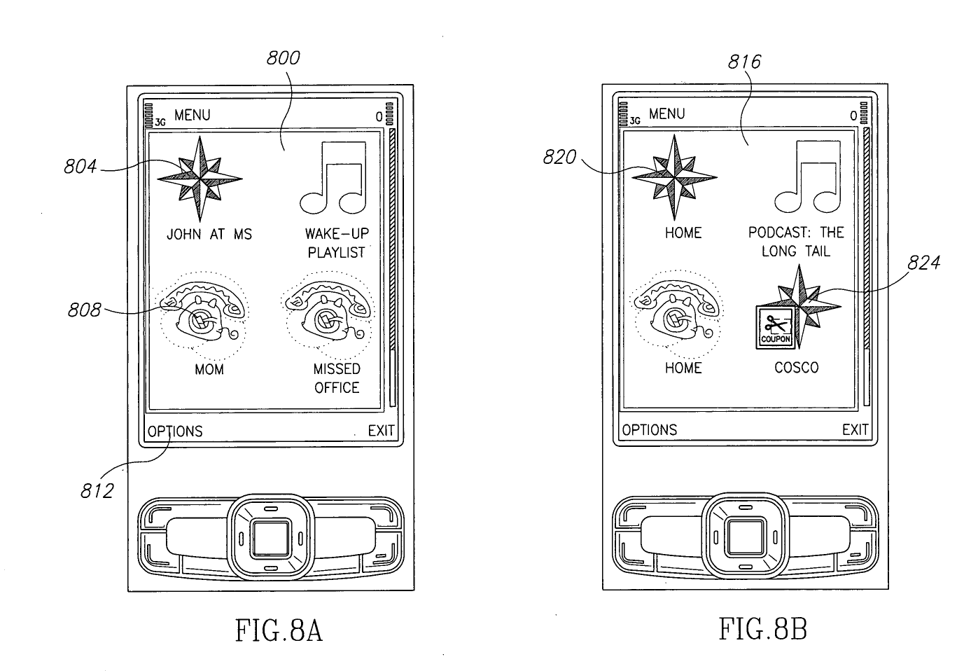

Referring now to FIGS. 8A and 8B, which show illustrations of a user interface of a mobile device operating in accordance with the disclosed method. Idle screen 800 comprises actions proposed to a user at particular circumstances, including time, location, having performed particular activities and receiving incoming events. The actions shown are preferably those having the highest priority, including for example navigating to a meeting with John 804, calling “mom” 808, or the like.

Activating “Options” button 812, or any other way of providing an indication may enable the user to start any of the applications, and also the option to view additional proposed actions, by choosing a “Next” option (not shown). After choosing the “Next” option, screen 816 is displayed, comprising additional options possibly having lower priority, such as navigating to the user's home 820 or navigating to a store 824, while also providing the user with a relevant coupon received from the store as a message or downloaded from the Internet. It will be appreciated that the graphic display is not limited to the shown examples, but can be adjusted to any type of mobile phone or any another device, using any user interface paradigm, including but not limited to windows, widgets, three dimensional presentation, or the like. The selected action may be activated by controls, touch screen elements, voice or any other input channel.

In some embodiments when a proposed action has high probability, for example probability exceeding a predetermined threshold, the proposed action can be executed automatically, without waiting for the user's selection.

The disclosed method and apparatus provide a user of an electronic device prediction and suggestion of proposed actions he may be likely to accept at the current circumstances, or at certain other circumstances. The suggested actions take into account historical activities made by the user, as well as incoming events, environmental data, external data, or any other source of information. The proposing is done by one or more engines, each relating to one or more aspects of operating the device. The actions proposed by all engines are merged and prioritized, and presented to a user in a manner that enables activation of any of the options, with the relevant settings and parameters.

It will be appreciated that multiple additions and variations can be designed along the guidelines of the presented application. For example, the user can activate a “what if” simulation, to get a list of proposed actions had the circumstances been different. For example, initiate a proposed actions generation if he had been in city X now, or if he had a meeting in location Y in twenty minutes from now. The user can also give absolute or relative precedence to predetermined actions, such as “always offer me to call home”, “increase probability of proposed actions associated with John”, “increase probability of sending a message over making a phone call”. The user can also eliminate other options, such as “never suggest me to call, send a message, or navigate to X”. In another example the information can be used for focused promotions, whether in the form of coupons or advertisements sent to the user or the device, based on activities or data related to the user or the device. In yet another alternative, an entity such as a restaurant can offer sponsorship for a meeting planned in the area.

Useful information can be attached to any action. For example, when navigating to a company the user did not have any connection with before, the system can download and attach the home page of the company, or the like. The proposed actions are not limited to the activities previously used by the user of the device. Rather, the system can suggest to the user to try new applications or features of the device which he or she never tried before.

It will be appreciated that information collected from one or a multiplicity of users can be used when proposing actions to other users. Such actions can be used as data supplied to engines for predicting the proposed actions. Alternatively, such data can be used as part of the engines and algorithms' operation. The data can be used for initializing the proposed action list actions before enough data about the specific user is available, or at a later time for updating the operation.

It will be appreciated that the disclosed embodiment is exemplary only, and that other embodiments can be designed for performing the methods of the disclosure. In particular, each component can be implemented as a collection of multiple components. Alternatively, a single component can provide the functionality of multiple described components.

It will be appreciated by persons skilled in the art that the present disclosure is not limited to what has been particularly shown and described hereinabove. Rather the scope of the present disclosure is defined only by the claims which follow.

What is claimed is:

1. A method for proposing a list of actions to a user of an electronic device, the method comprising:
receiving a request for generating proposed actions;
receiving a representation of historic or current information related to activities, events, or status associated with the device or with the user, or external to the device or the user;
receiving relevant information related to activities, events, or status, associated with the device or with the user, or external to the device or the user;
determining a proposed action list comprising an at least one proposed action to the user of the device, based on the historic information or the relevant information; and
activating an action from the proposed action list with relevant parameters.

2. The method of claim 1 wherein the relevant information is received from the device or from an external source.

3. The method of claim 1 wherein the relevant information is current information.

4. The method of claim 1 further comprising:
presenting to the user the proposed action list; and
receiving an indication from the user about an action to be activated.

5. The method of claim 1 further comprising:
receiving an external offer; and
combining the external offer into the proposed action list.

6. The method of claim 1 further comprising:
generating a random proposed action; and
combining the random proposed action into the proposed action list.

7. The method of claim 1 further comprising a step of providing an explanation as to why the proposed action was suggested.

8. The method of claim 1 wherein the at least one proposed action is selected from the group consisting of: calling a person or a phone number; sending a message to a person or a group of persons or a phone number or a group of phone numbers; sending a predetermined message to a person or a group of persons or a phone number or a group of phone numbers; providing navigation instructions to a destination; providing navigation instructions to a destination in which the device was present, or to a destination indicated by the user; providing navigation instructions for a route the device travelled; suggesting the user to go to a store; suggesting the user to go to a restaurant; suggesting the user to go to a place of business; reminding a meeting appearing in a calendar of the device or in another calendar; providing to a user navigation instructions for a meeting appearing in a calendar of the device or in another calendar; sending a message to a meeting organizer if the user will be late or not arrive to a meeting appearing in a calendar of the device or in another calendar; activating a memo or voice-memo application in proximity to a meeting in a calendar; activating a medical instrument; activating an application used by the user; activating an application not used by the user; browsing an internet page or a Wireless Application Protocol (WAP) page; setting an alarm clock; playing a game; listening to a music file or a playlist; watching a video clip; activating remote devices such as a smart home; taking pictures; activating mobile payment application; logging expenses; activating mobile TV application with or without specific channel selection; activating mobile Radio application with or without specific channel selection; enabling Geographic tagging; activating an instant messaging application; activating an instant message to a specific person; activating an instant message carrying specific content; tracking a flight status; adding a to-do item; activating currency unit converter; reminding the user to perform health related tasks; locating a wireless network; locating a Wi-Fi network; logging information from any application; sending an e-mail; and checking information.

9. The method of claim 1 wherein the historic information, current information or the relevant information relate to activities or events selected from the group consisting of: a call made from the device; a call received or missed by the device; a message sent from the device; an e-mail message received or sent by the device; a message received by the device; sending information to an external system; a memo or voice-memo created on the device or imported thereto; activation of a medical instrument; activation of an application used by the user; browsing an internet page or a Wireless Application Protocol (WAP) page; setting an alarm clock; photos taken or viewed; a game played; music listened to as a file or a playlist; a video clip watched; activation of a remote device such as a smart home; mobile payments; expenses logged; mobile TV activation or channel selection; mobile radio activation or channel selection; geographic tagging; instant messaging application activation with recipient and content information; flight information; to-do item insertion; currency unit converter usage; activation of a health related task; wireless network such as Wi-Fi connection, disconnection or connection duration; logging information from any application; receiving information from an external system; and an application executed by the device.

10. The method of claim 1 wherein the historic information, current information, or the relevant information relate to data selected from the group consisting of: raw time; time-zone; weather; temperature; humidity; daylight saving time information; lighting conditions; location data; raw location; relative location; music files or playlists; activation of remote devices, such as smart home; pictures taken; mobile payments application; expenses logging information; mobile TV application and channel selection information; mobile radio application and specific channel selection information; geographic tagging information; instant message application activation and target person information; flight status information; health related activities; to-do item creation or modification; currency unit converter information; information about activation or connection to new or existing wireless network such as Wi-Fi; logical location; proximity of a road or another physical location to a logical location; proximity to other users' device or entity; a received or missed call; a received message; a received e-mail; traffic information; personal information; a contact; a note; a message (SMS); an alarm; instant message; a document; a connection between a telephone number and a nickname; a user specific setting or modification made to the device settings; a received voice, picture, or video stream; processed voice, picture, or video stream; processing results of voice recognition, speaker verification, keyword spotting, full transcription, emotion recognition, or face recognition; a measure of an accelerometer or a barometer; a measure of a magnetic field sensor; a measure of a medical sensor; user initiated logging of an event; information received from an external source; information received from a social network; information received from an online data repository; an online application; web information; e-mail information; personal information; commercial information; a promotion; and other users' preference.

11. The method of claim 1 wherein determining the proposed action list uses at least one technique selected from the group consisting of: clustering; k-means clustering, K nearest neighbors; linear regression, Vector quantization; support vector machine; Hidden Markov Model; Conditional Random Fields, probit regression, logit regression, binomial regression, regression models of binary response variables, generalized linear model, rule based system, heuristic rules, expert systems, and artificial intelligence techniques.

12. The method of claim 1 wherein the representation of the historic information is a model.

13. The method of claim 1 further comprising a step of receiving an indication from the user relating to setting a priority for at least one action or to eliminating at least one action.

14. The method of claim 1 wherein the request for generating proposed actions is generated by a user or by an event, or received from a network; or generated according to a schedule or to a change in circumstances or data.

15. The method of claim 1 further comprising a step of updating the historic information with the action being activated.

16. The method of claim 1 further comprising a step of automatically activating the at least one proposed action.

17. The method of claim 1 wherein the at least one proposed action is a reoccurring action.

18. The method of claim 1 further comprising recording user selection for enhancement of the determination of the proposed action list.

19. The method of claim 1 further comprising receiving actions taken by multiple users for enhancement of the determination of the proposed action list.

20. The method of claim 1 wherein at least part of determining the proposed action list is performed by a processing unit external to the electric device.

21. An apparatus for proposing an action to a user of an electronic device, the action based on past activity, the apparatus comprising:
a collection component for receiving information related to activities, events, or status, associated with the user or with the device, or external to the device or to the user;
a storage device for storing the information or a representation thereof;
a request generation component for generating a request for generating a proposed action list;
a prediction component, comprising at least one prediction engine for compiling a proposed action list comprising at least one proposed action related to information collected by the collection component;
a user interface component for presenting the proposed action list to the user and receiving an action selected by the user; and
a suggestion activation component for activating the action selected by the user with relevant parameters.

22. The apparatus of claim 21 further comprising a model construction component for generating a model representation of the information related to activities, events, or status, associated with the user or with the device, or external to the device or to the user.

23. The apparatus of claim 21 wherein the prediction component comprises at least two prediction engines, and a combination component for combining proposed actions provided by the at least two prediction engines.

24. The apparatus of claim 21 wherein the at least one proposed action is selected from the group consisting of: calling a person or a phone number; sending a message to a person or a group of persons or a phone number or a group of phone numbers; sending a predetermined message to a person or a group of persons or a phone number or a group of phone numbers; providing navigation instructions to a destination; providing navigation instructions to a destination in which the device was present, or to a destination indicated by the user; providing navigation instructions for a route the device travelled; suggesting the user to go to a store; suggesting the user to go to a restaurant; suggesting the user to go to a place of business; reminding a meeting appearing in a calendar of the device or in another calendar; providing to a user navigation instructions for a meeting appearing in a calendar of the device or in another calendar; sending a message to a meeting organizer if the user will be late or not arrive to a meeting appearing in a calendar of the device or in another calendar; activating a memo or voice-memo application in proximity to a meeting in a calendar; activating a medical instrument; activating an application used by the user; activating an application not used by the user; browsing an internet page or a Wireless Application Protocol (WAP) page; setting an alarm clock; playing a game; listening to a music file or a playlist; watching a video clip; activating remote devices such as a smart home; taking pictures; activating mobile payment application; logging expenses; activating mobile TV application with or without specific channel selection; activating mobile Radio application with or without specific channel selection; enabling Geographic tagging; activating an instant messaging application; activating an instant message to a specific person; activating an instant message carrying specific content; tracking a flight status; adding a to-do item; activating currency unit converter; reminding the user to perform health related tasks; locating a wireless network; locating a Wi-Fi network; logging information from any application; sending an e-mail; and checking information.

25. The apparatus of claim 21 wherein the information is related to activities or events selected from the group consisting of: a call made from the device; a call received or missed by the device; a message sent from the device; an e-mail message received or sent by the device; a message received by the device; sending information to an external system; a memo or voice-memo created on the device or imported thereto; activation of a medical instrument; activation of an application used by the user; browsing an internet page or a Wireless Application Protocol (WAP) page; setting an alarm clock; photos taken or viewed; a game played; music listened to as a file or a playlist; a video clip watched; activation of a remote device such as a smart home; mobile payments expenses logged; mobile TV activation or channel selection; mobile radio activation or channel selection; geographic tagging; instant messaging application activation with recipient and content information; flight information; to-do item insertion; currency unit converter usage; activation of a health related task; wireless network such as Wi-Fi connection, disconnection or connection duration; logging information from any application; receiving information from an external system; and an application executed by the device.

26. The apparatus of claim 21 wherein the information is related to data selected from the group consisting of: raw time; time-zone; weather; temperature; humidity; daylight saving time information; lighting conditions; location data; raw location; relative location; music files or playlists; activation of remote devices, such as smart home; pictures taken; mobile payments application; expenses logging information; mobile TV application and channel selection information; mobile radio application and specific channel selection information; geographic tagging information; instant message application activation and target person information; flight status information; health related activities; to-do item creation or modification; currency unit converter information; information about activation or connection to new or existing wireless network such as Wi-Fi; logical location; proximity of a road or another physical location to a logical location; proximity to other users' device or entity; a received or missed call; a received message; a received e-mail; traffic information; personal information; a contact; a note; a message (SMS); an alarm; instant message; a document; a connection between a telephone number and a nickname; a user specific setting or modification made to the device settings; a received voice, picture, or video stream; processed voice, picture, or video stream; processing results of voice recognition, speaker verification, keyword spotting, full transcription, emotion recognition, or face recognition; a measure of an accelerometer or a barometer; a measure of a magnetic field sensor; a measure of a medical sensor; user initiated logging of an event; information received from an external source; information received from a social network; information received from an online data repository; an online application; web information; e-mail information; personal information; commercial information; a promotion; and another users' preference.

27. The apparatus of claim 21 wherein the at least one prediction engine uses at least one technique selected from the group consisting of: clustering; k-means clustering, K nearest neighbors; linear regression, Vector quantization; support vector machine; Hidden Markov Model; Conditional Random Fields, probit regression, logit regression, binomial regression, regression models of binary response variables, generalized linear model, rule based system, heuristic rules, expert systems, and artificial intelligence techniques.

28. The method of claim 21 wherein the received information is used for enhancing the at least one prediction component.

29. A computer readable storage medium containing a set of instructions for a general purpose computer, the set of instructions comprising:
receiving a request for generating proposed actions for an electronic device;
receiving a representation of historic information related to activities, events, or status, associated with the electronic device or with a user of the electronic device, or external to the device or to the user;
receiving relevant information related to activities, events, or status, associated with the device or with the user or external to the device or to the user;
determining a proposed action list comprising an at least one proposed action to the user of the device, based on the historic information or the relevant information; and
activating an action from the proposed action list with relevant parameters.
